(19) United States
(12) Patent Application Publication
(10) Pub. No.: US 2008/0138757 A1
(43) Pub. Date: Jun. 12, 2008

(54) ORTHODONTIC BRACE WITH REDUCED PROFILE

(75) Inventors: Ming-Lai Lai, Arcadia, CA (US); George Anka, Kawasaki (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/609,363

(22) Filed: Dec. 12, 2006

(51) Int. Cl. A61C 7/28

(52) U.S. Cl. 433/10

(57) ABSTRACT

An orthodontic brace includes a set of orthodontic brackets for a dental arch that comprises at least one central incisor bracket, one lateral incisor bracket, and one cuspid bracket. Each bracket of the set lacks occlusal tiewings. Without occlusal tiewings, interferences with opposing teeth are substantially reduced and patient comfort, hygiene, and bracket aesthetics are enhanced.

### BACKGROUND OF THE INVENTION

1. Field of the Invention

The present invention broadly relates to braces used in orthodontic treatment. More particularly, this invention relates to orthodontic braces that have a reduced profile.

2. Description of the Related Art

Orthodontic therapy is a specialized type of treatment within the field of dentistry, and involves movement of malpositioned teeth to improved locations along the dental arches. Orthodontic treatment often enhances the patient's facial appearance, especially in regions near the front of the oral cavity. Orthodontic treatment can also improve the patient's occlusion so that the teeth function better with each other during mastication.

Many types of orthodontic treatment programs involve the use of a set of appliances and archwires that are commonly known collectively as “braces”. During such treatment programs, tiny slotted appliances known as brackets are fixed to the patient's anterior, cuspid and bicuspid teeth. The slots of these brackets receive an archwire, allowing the archwire to guide the teeth into orthodontically correct locations during the course of treatment. End sections of the archwires are often captured in tiny appliances known as molar tubes that are fixed to the patient's molar teeth.

Orthodontic brackets often have small wings known as “tiewings” that are connected to a body of the bracket. Once the bracket has been attached to a tooth and an archwire has been received into the archwire slot of the bracket, a ligature is coupled to the bracket in order to retain the archwire in the archwire slot. One common type of commercially available orthodontic ligature is a small, elastomeric O-ring that is installed by stretching the O-ring along a path behind the tiewings and over the facial side of the archwire. Another option is to use stainless steel ligature wire, which can similarly be looped along a path behind the tiewings and over the facial side of the archwire and tightly secured by twisting together the ends.

Certain types of orthodontic brackets known as self-ligating brackets are provided with a latch that allows an archwire to be coupled to the brackets without using ligatures or ligature wire. This latch may comprise a movable clip, spring member, cover, shutter, bail or other structure that is connected to the bracket body for retaining the archwire in the archwire slot. Self-ligating brackets can allow free and easy sliding of the archwire through the archwire slot, and this in turn can facilitate movement of teeth in early stages of treatment. While not required, tiewings are still used on many self-ligating brackets since they offer the practitioner increased flexibility in achieving specific treatment objectives. For example, a practitioner may elect to use ligatures for cases in which increased friction (i.e. resistance to sliding) is desirable. This in turn can help retain the teeth in their proper orthodontic positions when using a full sized archwire in the finishing stages of treatment.

Self-ligating or otherwise, it is common for brackets with tiewings to have one or more tiewings residing on both the gingival and occlusal sides of the bracket. Such a design offers convenient paths for the ligature to cross over the facial side of the archwire. Brackets with four tiewings are especially common, and allow the ligature to secure the archwire in various configurations, including standard, double-over tie, figure-8, and corner-to-corner, each of which can be used advantageously by one skilled in the art.

On occasion, a bracket on one arch (typically the lower arch) interferes with teeth on the opposite arch. In response, a practitioner may delay bonding of an appliance until the obstructive teeth have been safely moved out of the way. While this is one solution, this delay extends treatment time. Alternatively, orthodontic practitioners may elect to remove a portion or all of the tie wings from the problematic bracket, by grinding or some other means, to eliminate interferences. Using smaller sized appliances may help alleviate occlusal interferences. However, it can be challenging to reduce the size of an appliance without compromising its functionality.

There is a present need in the art for an orthodontic brace that includes appliances that are smaller in size, especially a brace which can alleviate difficulties with occlusal interferences.

### SUMMARY OF THE INVENTION

This invention provides a brace for a dental arch that alleviates problems with occlusal interference and enhances patient comfort, hygiene, and bracket aesthetics. This brace comprises a set of orthodontic brackets and includes: at least one central incisor bracket, at least one lateral incisor bracket, and at least one cuspid bracket, wherein each bracket of the set includes a base, a body extending outwardly from the base, and an archwire slot extending across the body, wherein each bracket of the set includes at least one gingival tiewing and lacks any occlusal tiewing.

Another aspect of the invention is directed towards a brace that comprises a set of orthodontic brackets that includes at least one central incisor bracket, at least one lateral incisor bracket, and at least one cuspid bracket, wherein each bracket of the set includes a base, a body extending outwardly from the base, an archwire slot extending across the body and a single gingival tiewing, while lacking occlusal tiewings.

Yet another aspect of the invention is directed towards a brace that comprises a set of orthodontic brackets that includes at least one central incisor bracket, at least one lateral incisor bracket, and at least one cuspid bracket, wherein each bracket of the set includes a base, a body extending outwardly from the base, an archwire slot extending across the body, at least one gingival tiewing, and a latch for releasably retaining an archwire in the archwire slot of the bracket, while lacking occlusal tiewings.

Still other aspects of the invention are directed towards extending the set of orthodontic brackets to include 1^{st} bicuspid and 2^{nd} bicuspid brackets. Yet still other aspects of the invention are directed towards extending the set of orthodontic brackets to include a bracket with a latch comprising a single centrally located clip, or with a latch comprising clips that also function as tiewings.

In the aforementioned aspects of the invention, latches and/or gingival tiewings enable an archwire to be coupled to the brackets. Moreover, the absence of occlusal tiewings allows interferences between the bracket and teeth positioned on the opposite dental arch to be minimized or eliminated. This is especially useful in a “deep bite” situation in which the upper incisors descend over the lower anterior teeth in occlusion. With fewer bracket/tooth interferences, the likelihood of premature, spontaneous debonding of the interfering bracket and/or enamel damage are likewise reduced.

The absence of occlusal tiewings also reduces potential irritation, swelling, and overall patient discomfort caused by brackets rubbing against the cheeks and lips of a patient throughout treatment. Hygiene is improved as well because less food and plaque is trapped beneath the tiewings during treatment. Improved patient hygiene in turn promotes improved gum health and reduced incidence of dental caries and/or decalcification. Lastly, this brace offers improved aesthetic appeal, since there are no occlusal tiewings protruding from the bracket body. The inventive orthodontic brace uses brackets that are visibly smaller.

Aspects of the present invention are set out in the detailed description that follows and are illustrated in the accompanying drawings.

### BRIEF DESCRIPTION OF THE DRAWINGS

FIG. 1 is a front elevational view showing the lower teeth of an exemplary patient undergoing orthodontic treatment, wherein orthodontic appliances are fixed to the teeth and an archwire connected to the appliances by means of latches on said appliances.

FIG. 2 is a front view of an individual bracket shown in FIG. 1, looking at the bracket towards its facial side.

FIG. 3 is a side view of an individual bracket shown in FIGS. 1 and 2, looking at the bracket towards its mesial side.

FIG. 4 is a perspective view of an individual bracket shown in FIGS. 1-3, looking at the bracket towards its mesial, facial, and occlusal sides.

FIG. 5 is a side view of an assembly depicting the bracket shown in FIGS. 1-3 coupled to an archwire by using an elastic ligature, looking at the assembly towards its mesial side.

FIG. 6 is a perspective view of an assembly depicting the bracket shown in FIGS. 1-3 coupled to an archwire by using an elastic ligature, looking at the assembly towards its mesial, facial, and occlusal sides.

FIG. 7 is a front view of an orthodontic bracket according to another embodiment of the invention, looking at the bracket towards its facial side.

FIG. 8 is a side view of the bracket shown in FIG. 5, looking at the bracket towards its mesial side.

FIG. 9 is a perspective view of the bracket shown in FIGS. 5 and 6, looking at the bracket towards its mesial, facial, and occlusal sides.

FIG. 10 is a perspective view of an orthodontic bracket according to another embodiment of the invention, looking at the bracket towards its mesial, facial, and occlusal sides.

FIG. 11 is a front view of an orthodontic bracket according to another embodiment of the invention, looking at the bracket towards its facial side.

FIG. 12 is a side view of the bracket shown in FIG. 9, looking at the bracket towards its distal side.

FIG. 13 is a perspective view of the bracket shown in FIGS. 9 and 10, looking at the bracket towards its mesial, facial, and gingival sides.

FIG. 14 is a perspective view of an orthodontic bracket according to another embodiment of the invention, looking at the bracket towards its distal, facial, and occlusal sides.

### DEFINITIONS

“Mesial” means in a direction toward the center of a patient's curved dental arch.

“Distal” means in a direction away from the center of a patient's curved dental arch.

“Occlusal” means in a direction toward the outer tips of a patient's teeth.

“Gingival” means in a direction toward the patient's gum or gingiva.

“Facial” means in a direction toward the patient's lips.

“Lingual” means in a direction toward the patient's tongue.

### DETAILED DESCRIPTION OF THE PREFERRED EMBODIMENTS

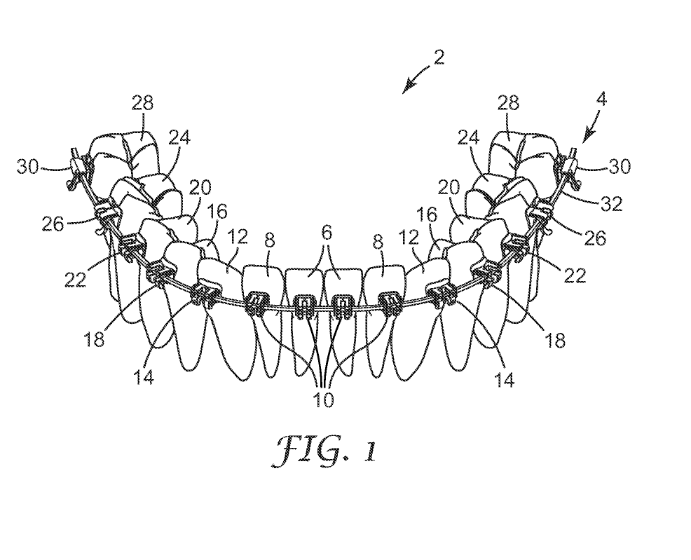

FIG. 1 shows an example of a lower dental arch broadly designated by the numeral 2 of an orthodontic patient that is undergoing orthodontic treatment. An orthodontic brace 4 is connected to the teeth of the lower dental arch 2. The brace 4 includes a set of appliances as well as an archwire that receives the appliances, as will be described in greater detail below.

In this example, each tooth in the lower dental arch 2 is coupled to an orthodontic appliance. Specifically, lower central teeth 6 and lower lateral teeth 8 are coupled to lower anterior brackets 10, cuspid teeth 12 are coupled to cuspid brackets 14, 1^{st} bicuspid teeth 16 are coupled to 1^{st} bicuspid brackets 18, 2^{nd} bicuspid teeth 20 are coupled to 2^{nd} bicuspid brackets 22, first molars 24 are coupled to molar tube 26, and second molars 28 are coupled to second molar tubes 30. Appliances 10, 14, 18, and 22 are of a type known as “self-ligating” brackets. Features associated with these brackets shall be described in detail in subsequent illustrations. For exemplary purposes, illustrated brackets 10, 14, 18, and 22 and molar tubes 26 and 30 are metal appliances directly bonded to the patient's tooth enamel, although other appliances and/or methods of coupling could be used. An archwire 32 is received in the slots of brackets 10, 14, 18, and 22, and molar tubes 26 and 30.

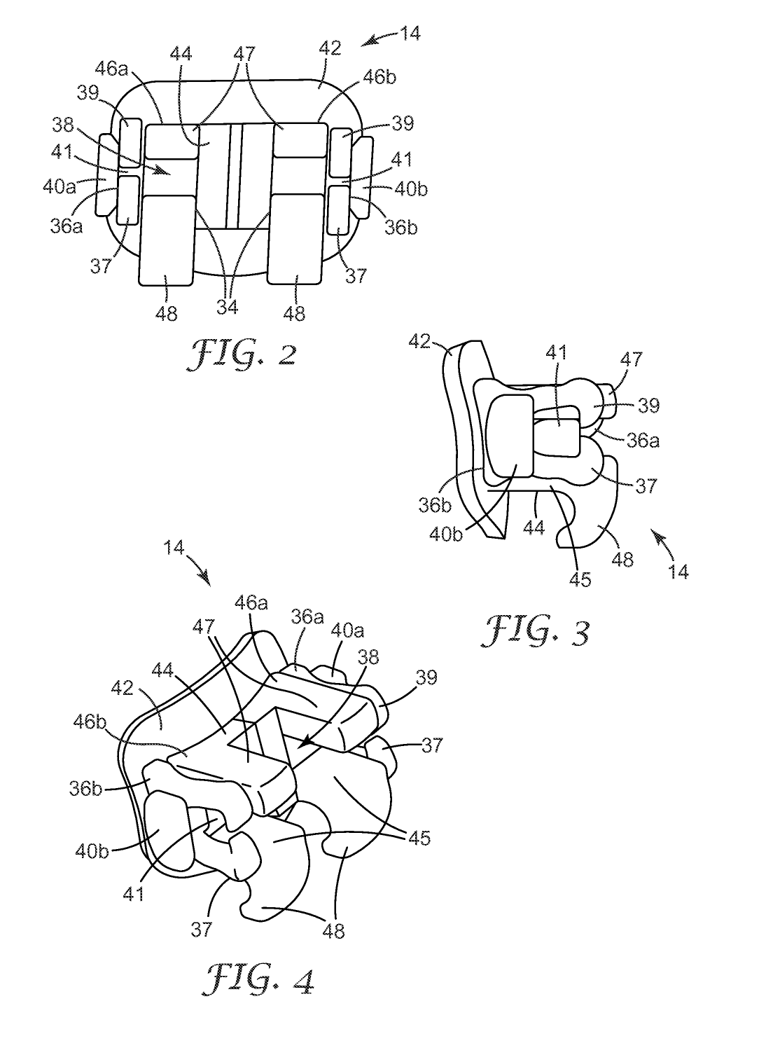

The exemplary cuspid bracket 14 used in orthodontic brace 4 is shown from three different perspectives in FIGS. 2-4. The bracket 14 includes a base 42 and a body 44 that extends outwardly from base 42. The body 44 includes a mesial side 46a along with a distal side 46b. Body 44 also includes a pair of gingival posts 45 and a pair of occlusal posts 47. An elongated archwire slot 38 extends in a generally mesial-distal direction across the body 44 from the mesial side 46a to the distal side 46b and between gingival posts 45 and occlusal posts 47. Archwire slot 38 has an overall rectangular shape in transverse cross-sectional view.

As previously mentioned, bracket 14 is of a type known as a “self-ligating” bracket. To this end, the bracket 14 has a latch that comprises a mesial spring clip 36a and a distal spring clip 36b. Mesial spring clip 36a and distal spring clip 36b each includes a first section 37 and a second section 39 spaced from first section 37. Between first section 37 and second section 39 resides archwire-receiving region 41, which is aligned with archwire slot 38. When an orthodontic archwire (not shown in FIGS. 2-4) is urged in a direction toward the bottom of the archwire slot 38, the clips 36a and 36b deflect and spread open to enable the archwire to be moved fully into archwire receiving region 41, and hence also, archwire slot 38. Once the archwire is seated into archwire slot 38, the inherent resiliency of the clips 36a and 36b causes first section 37 and second section 39 to shift to their relaxed, closed position as depicted in FIGS. 2-4 for retaining the archwire in archwire slot 38.

Preferably, the sides of the clips 36a and 36b deflect outwardly to a slot-open orientation and release the archwire from the archwire slot 38 whenever the force exerted by the archwire on the bracket 14 exceeds a certain minimum value. The minimum value is sufficiently high to prevent the archwire from unintentionally releasing from the archwire slot 38 during the normal course of orthodontic treatment. As such, the archwire can exert forces on the bracket 14 sufficient to carry out the intended treatment program and move the associated tooth as desired. Preferably, the clips 36a and 36b release the archwire from archwire receiving region 41, and hence archwire slot 38, in a direction perpendicular and away from the lingual side of the archwire slot 38 whenever the archwire exerts a force in the same direction on the bracket 14 that is in the range of about 0.2 lb (0.1 kg) to about 11 lbs (5 kg), more preferably in the range of about 0.4 lb (0.2 kg) to about 5.5 lbs (2.5 kg), and most preferably in the range of about 0.4 lb (0.2 kg) to about 2.7 lbs (1.25 kg).

Preferably, the minimum value for self-release (i.e., self-opening) of the clips 36a and 36b is together substantially less than the force required in the same direction to debond the bracket 14 from the associated tooth in instances where the bracket 14 is directly bonded to the tooth surface. The minimum value for self-release of the clips 36a and 36b is preferably less than about one-half of the force required in the same direction to debond the bracket 14 from the associated tooth. For example, if the expected bond strength of the adhesive bond between the bracket 14 and the associated tooth is 16 lbs (7.3 kg) in the facial direction, the clips 36a and 36b are constructed to self-release the archwire whenever the archwire exerts a force in the same facial direction on the appliance 36a and 36b that is somewhat greater than about 8 lbs (3.6 kg).

Each of clips 36a and 36b is preferably made from a flat annealed superelastic material having a pickled surface. Preferably, the superelastic material is nitinol having a nickel content of 55.97% by weight and an A_{f} of 10°±5° C. The nitinol is cold worked to 37.5% and has a thickness in the range of about 0.012 in. (0.3 mm) to about 0.016 in. (0.4 mm). The clips 36a and 36b are first cut in a rough cutting laser process, and then optionally cut along their edges for an additional one or more times using an laser cutting process in order to smooth the edges.

Other details and features of the latch and the clips 36a and 36b are set out in applicants' issued patents entitled, “ORTHODONTIC APPLIANCE WITH SELF-RELEASING LATCH”—U.S. Pat. Nos. 6,302,688 and 6,582,226, and “ORTHODONTIC APPLIANCE WITH FATIGUE-RESISTANT ARCHWIRE RETAINING LATCH”—U.S. Pat. No. 7,014,460, which are expressly incorporated by reference herein.

The clips 36a and 36b are each held in place by mesial cap 40a and distal cap 40b, respectively. In this embodiment, the caps 40a and 40b are considered as part of the body 44 and attached to the mesial side 46a and the distal side 46b, respectively, as mentioned above. The caps 40a and 40b are fixed to protrusions that extend in a mesial-distal direction from the central section of the body 44, and the protrusions are arranged to retain the clips 36a and 36b in place. For example, protrusions may be provided along the sides of the archwire slot 38 as well as along a portion or all of the lingual side of the clips 36a and 36b. The protrusions may be integral with either the central section or the caps 40a and 40b and then fixed to the other of the central section or the caps 40a and 40b by a welding or brazing operation. Protrusions and caps can be integral with the bracket body using the metal injection molding process to fabricate the bracket. Bracket 14 also includes a pair of tiewings 48 that protrude from the gingival posts 45 of the body 44. Tiewings 48 are parallel to each other and initially extend in the gingival direction from gingival posts 45 then bend in a gradual curve towards the lingual direction towards base 42.

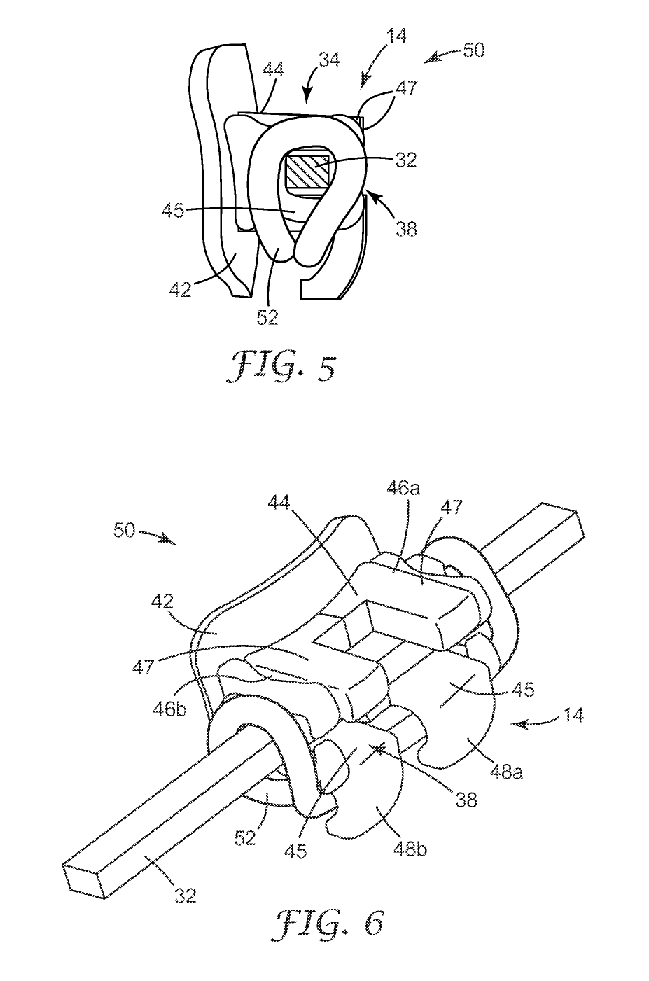

FIGS. 5 and 6 demonstrate, in side view and perspective view, how tiewings 48 (designated here as 48a and 48b) can be advantageously used to provide an alternate route for coupling archwire 32 to bracket 14 in orthodontic brace 4.

Here, assembly 50 includes the bracket 14 and archwire 32 that is received in archwire slot 38. Assembly 50 furthermore includes elastic ligature 52, which travels along a continuous path over the facial, occlusal, and lingual sides of archwire 32 on the distal side 46b of bracket 14, beneath distal tiewing 48b, beneath mesial tiewing 48a, over the lingual, occlusal, and facial sides of archwire 32 on the mesial side 46a, beneath mesial tiewing 48a, then finally beneath distal tiewing 48b. To arrive at this configuration, elastic ligature 52 is first looped around mesial and distal tiewings 48a and 48b and gingival posts 45. Archwire 32 is then received into archwire slot 38. Then the portion of elastic ligature 52 located occlusal to archwire 32 is stretched up and over the labial side of archwire 32 and finally secured beneath mesial and distal tiewings 48a and 48b, respectively.

In such fashion, archwire 32 is securely retained in archwire slot 38, demonstrating a secondary means for a practitioner to couple archwire 32 to bracket 14. The configuration shown in assembly 50 for coupling archwire 32 to bracket 14 is easily extended to other types of ligatures such as stainless steel ligature ties. It is likewise straightforward to extend the configuration shown in assembly 50 to couple archwire 32 to other member brackets 10, 18, and 22 of orthodontic brace 4 on dental arch 2. Using bracket 14, a practitioner has the option of coupling archwire 32 to bracket 14 using clips 36a and 36b alone, or in combination with an elastic ligature 52 (or similar ligature tie) looped around tiewings 48a and 48b as described above.

Note here that bracket 14 lacks occlusal tiewings. The phrase “lacks occlusal tiewings” as used herein denotes that there is no recess, notch, protrusion or otherwise retaining feature present on the bracket that can be used to support a ligature on the occlusal side of the archwire slot during the course of orthodontic treatment. Preferably, the bracket 14 has no structure that has all of the following characteristics: (a) it is located in a facial direction relative to the base, (b) it is located in an occlusal direction relative to an occlusal reference plane passing through the center of the archwire slot, (c) it extends in an occlusal direction or in a generally occlusal direction, and (d) it is sufficiently large to support a ligature during the course of orthodontic treatment.

In another embodiment, exemplary bracket 54 is used in place of bracket 14 in orthodontic brace 4. Bracket 54 is shown in FIGS. 7-9 in front view, side view, and perspective view, respectively. Bracket 54 includes a base 42a and a body 44a that extends outwardly from base 42a. The body 44a includes a distal side 46c along with a mesial side 46d. Body 44a also includes two gingival posts 45a and two occlusal posts 47a. An elongated archwire slot 38a extends in a generally distal-mesial direction across the body 44 from the distal side 46c to the mesial side 46d and between gingival posts 45a and occlusal posts 47a. Bracket 54 also includes a pair of tiewings 49 that are parallel and protrude from gingival posts 45a of body 44a initially in the gingival direction, then gradually curve towards the lingual direction. In this embodiment, an archwire (not shown) can be coupled to bracket 54 using an elastic ligature or stainless steel ligature tie as shown previously using the configuration depicted in FIGS. 5 and 6.

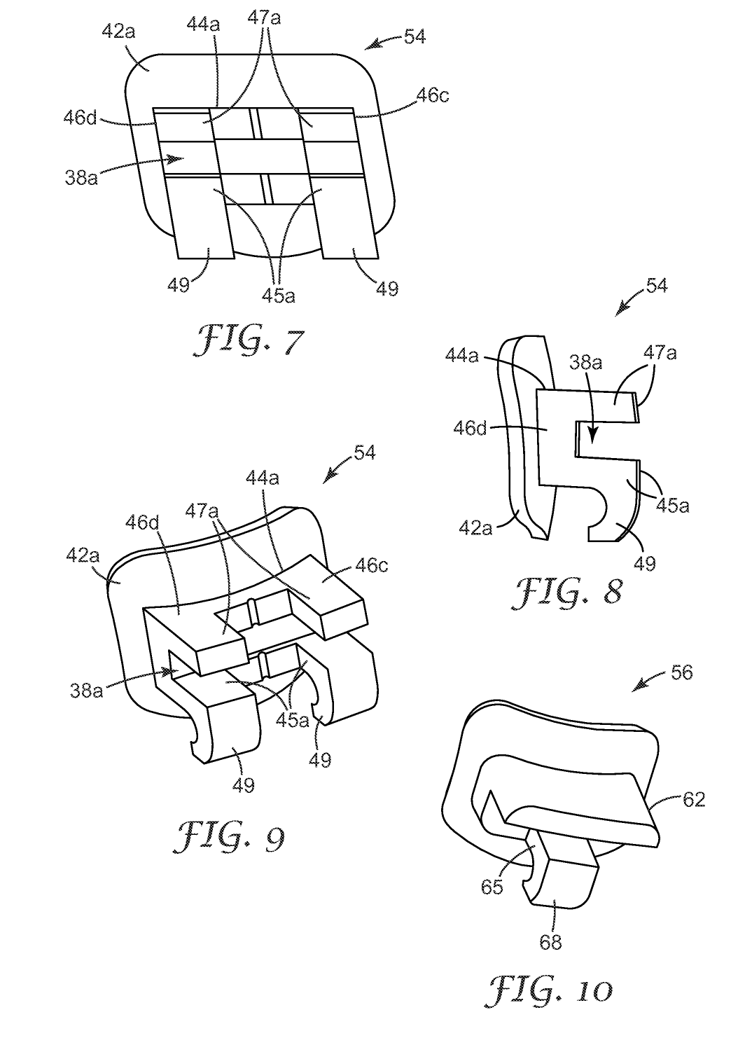

In still another embodiment, exemplary bracket 56 is used in place of bracket 14 in orthodontic brace 4. Bracket 56 is shown in FIG. 10 in perspective view and is essentially identical to bracket 54 depicted in FIGS. 7-9 except bracket 56 includes a single occlusal post 62, single gingival post 65, and single tiewing 68 that protrudes from gingival post 65. Gingival tiewing 68 protrudes in a perpendicular fashion from gingival post 65 in the gingival direction and then curves in a gradual arc towards the lingual direction. An archwire (not shown) can be coupled to bracket 56 using an elastic ligature or stainless steel ligature tie using a configuration similar to that shown in FIGS. 5 and 6 as described previously.

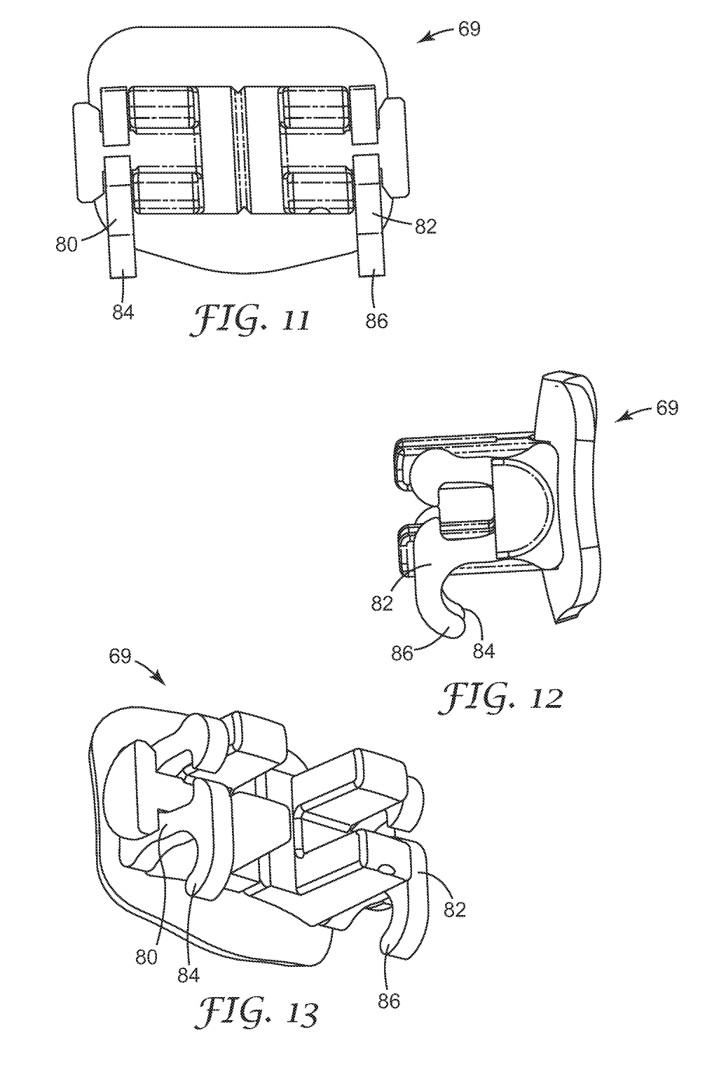

Yet another embodiment uses exemplary bracket 69, illustrated by FIGS. 11-13 in front view, side view, and perspective view, respectively. Bracket 69 can be used in place of bracket 14 in orthodontic brace 4, and is nearly identical to bracket 14 except tie wings 84 and 86 protrude not from the gingival posts but rather from clips 80 and 82, respectively. Tiewings 84 and 86 are parallel and initially protrude from clips 80 and 82 in the gingival direction and then bend in a gradual curve towards the lingual direction. Bracket 69 has the ability to retain an archwire using clips 80 and 82 alone, or in combination with using an elastic ligature or stainless steel ligature tie (not pictured) guided around tiewings 84 and 86, in a manner shown in FIGS. 5 and 6 previously.

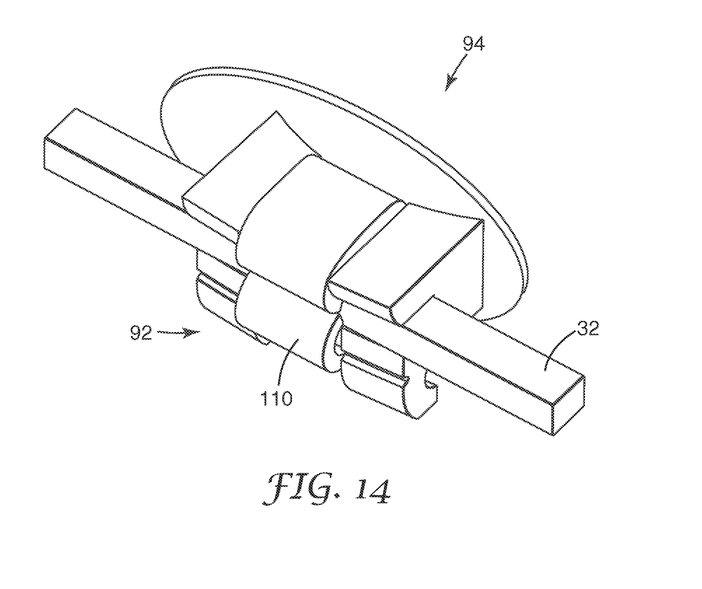

An assembly 92 according to yet another embodiment of the invention is illustrated in FIG. 14 in perspective view. Assembly 92 includes exemplary bracket 94 coupled to archwire 32. In this embodiment, bracket 94 is used in place of bracket 14 of orthodontic brace 4. Bracket 94 is essentially identical to bracket 14 except the latch includes only one centrally located spring clip 110. Bracket 94 has the ability to retain an archwire using clip 110 alone or in combination with using an elastic ligature or stainless steel ligature tie (not shown) in a manner shown in FIGS. 5 and 6 previously.

While the embodiments described above were exemplified on a lower dental arch, it is straightforward to adapt these embodiments for use on an upper dental arch. It should also be understood that the brackets included in any of the above embodiments can be formed from a variety of materials, including metals, ceramics, polymers, or any combination therefrom. Examples of such materials include, but are not limited to, stainless steel, polycrystalline alumina, and fiber-reinforced polycarbonate.

The examples described above are intended to exemplify the various aspects and benefits of the invention. However, those skilled in the art may recognize that a number of variations and additions to the appliances described above may be made without departing from the spirit of the invention. Accordingly, the invention should not be deemed limited to the specific embodiments set out above in detail, but instead only by a fair scope of the claims that follow, along with their equivalents.

What is claimed is:

1. An orthodontic brace comprising a set of orthodontic brackets for a dental arch, the set including at least one central incisor bracket, at least one lateral incisor bracket and at least one cuspid bracket, wherein each bracket of the set includes a base, a body extending outwardly from the base and an archwire slot extending across the body, wherein each bracket of the set includes at least one gingival tiewing and lacks any occlusal tiewing.

2. An orthodontic brace according to claim 1 wherein each bracket of the set is a lower dental arch bracket.

3. An orthodontic brace according to claim 1 wherein the set also includes at least one first bicuspid bracket.

4. An orthodontic brace according to claim 3 wherein the set additionally includes at least one second bicuspid bracket.

5. An orthodontic brace according to claim 1 wherein the body of each bracket of the set includes a pair of occlusal posts and a pair of gingival posts, and wherein the archwire slot of each bracket extends between the occlusal posts and the gingival posts of each corresponding bracket.

6. An orthodontic brace according to claim 5 wherein the at least one gingival tiewing of each bracket of the set includes two gingival tiewings each connected to a respective gingival post of the corresponding bracket.

7. An orthodontic brace according to claim 1 wherein each bracket of the set includes a latch for releasably retaining an archwire in the archwire slot of the corresponding bracket.

8. An orthodontic brace according to claim 7 wherein the latch of each bracket comprises at least one clip.

9. An orthodontic brace according to claim 7 wherein the latch of each bracket comprises a mesial clip and a distal clip, and wherein each clip presents an archwire-receiving region in alignment with the archwire slot of the corresponding bracket.

10. An orthodontic brace according to claim 9 wherein each clip includes a first section and a second section that move away from each other when an archwire is urged against the clip in order to admit the archwire into the archwire slot.

11. An orthodontic brace according to claim 9 wherein each clip self-releases the archwire from the archwire slot whenever the force presented by the archwire against the clip is greater than a certain value.

12. An orthodontic brace according to claim 9 wherein each clip includes a first section and a second section spaced from the first section, and wherein the at least one gingival tiewing of each bracket of the set comprises a gingival tiewing connected to the mesial clip and a gingival tiewing connected to the distal clip.

13. An orthodontic brace according to claim 1 wherein each bracket of the set has only a single gingival tiewing.
